(19) United States
(12) Patent Application Publication
(10) Pub. No.: US 2003/0215080 A1
(43) Pub. Date: Nov. 20, 2003

(54) Presence-aware private branch exchange (PBX)

(76) Inventor: Michael S. Wengrovitz, Concord, MA (US)

Correspondence Address: ALCATEL INTERNETWORKING SYSTEM, INC., ALCATEL-INTELLECTUAL PROPERTY DEPARTMENT, 3400 W. PLANO PARKWAY, MS LEGL2, PLANO, TX, 75075, US

(21) Appl. No.: 10/436,184

(22) Filed: May 12, 2003

Related U.S. Application Data
(60) Provisional application No. 60/381,626, filed on May 17, 2002.

(51) Int. Cl. H04M 7/00

(52) U.S. Cl. 379/219

(57) ABSTRACT

A presence aware Private Branch Exchange (PBX) system is provided that has capabilities of presence subscription, notification and management. The system sends notifications to subscribed user agent clients (UACs) indicating that the telephone set is off-hook or on-hook. If the telephone set user interacts with a PBX's IVR or voicemail systems, additional types of notification messages such as “out-of-the-office”, “do-not-disturb”, and the like may also be sent. The system may also provide capability for granting or rejecting subscriptions to UACs that want to monitor a telephone user's presence state. Optional external subscription and notification servers, coupled to the PBX via IP and telephony trunks, may operate on behalf of the PBX and provide additional presence services.

### CROSS-REFERENCE TO RELATED APPLICATION(S)

This application claims the benefit of U.S. provisional application No. 60/381,626, filed May 17, 2002, the content of which is incorporated herein by reference.

### FIELD OF THE INVENTION

This invention relates generally to Internet telephony, and more particularly, to providing presence subscription, notification and management capabilities using a presence-aware Private Branch Exchange (PBX) system.

### BACKGROUND

Session Initiation Protocol (SIP) is an Internet Protocol (IP) for establishing, modifying, and terminating multimedia network communications sessions. Details about the SIP signaling protocol are set forth in Internet Engineering Task Force Request for Comment 2543 entitled “SIP: Session Initiation Protocol,” March 1999 (hereinafter referred to as RFC 2543), which is incorporated herein by reference. SIP provides an alternative to Private Branch Exchange (PBX) and H.323 telephony signaling protocols. SIP provides an alternative to Private Branch Exchange (PBX) and H.323 telephony signaling protocols.

One of the most important application areas enabled by the SIP protocol relates to presence. By using standard SIP messages, a user agent client (UAC) can accept presence subscriptions from other UACs and subsequently provide presence notification to other UACs whenever its state changes. Presence also facilitates numerous next-generation applications such as polite-calling, call control based on user presence, ad-hoc conference setup based on participant availability and the like.

Details about presence are set forth in Internet Engineering Task Force Request for Comment 2778 and 2779, entitled “A Model for Presence and Instant Messaging,” February 2000 (hereinafter referred to as RFC 2778) and “Instant Messaging/Presence Protocol Requirements,” February 2000 (hereinafter referred to as RFC 2779), respectively, which are incorporated herein by reference.

In this context, subscribe refers to the process by which a first UAC requests permission to monitor a second UAC's presence state and the second UAC grants permission for the first UAC to monitor its presence state; notification refers to the process by which a first UAC sends its own presence state to other UACs by using, for example, a Session Description Protocol (SDP) body which contains the specific definition of presence states within an XML document; and management refers to the process of how a first UAC changes its own presence state (manually or automatically) and where the first UAC displays the presence state of other UACs.

One example of a SIP presence aware UAC is MICROSOFT® RTC MESSENGER™. With RTC MESSENGER™, each PC-based UAC has the capability of subscribing or being subscribed to by other UACs, providing notification to or being notified by other UACs, displaying the presence state of itself and/or other UACs to which it has subscribed, and managing its own presence state by selecting “on the phone”, “online”, “busy”, “away”, “out to lunch”, and/or the like, so that other subscribed UACs are correspondingly notified.

RTC MESSENGER™ is also an example of a symmetric presence agent. In general, a symmetric presence agent can subscribe to other UACs and can be subscribed to (i.e., grant subscriptions to) by other UACs, can send notifications to other UACs and can receive notifications from other UACs, and can change its own presence state and can display the presence states of other UACs.

Nevertheless, not all UACs are symmetric. For example, a non-symmetric UAC may be able to send notifications to other UACs but not able to receive notifications from other UACs, or it may be able to grant subscriptions to other UACs but not able to subscribe to other UACs.

RTC MESSENGER™ could also be used in a configuration with a presence aware SIP proxy and media server. In such a case, if a call was made by a first UAC to a second UAC and the second UAC was busy or otherwise unavailable, the first UAC would be directed to the media server, which plays music, advertisements, executes voice XML interactive voice response scripts and/or the like, so that when the second UAC becomes available, the SIP proxy server is notified so that it transfers the call to the second UAC or otherwise initiates a call to the first UAC to let it know the second UAC is available.

Unfortunately, there is no presence integration between a UAC, such as, RTC MESSENGER™, and the PBX telephone. For example, RTC MESSENGER™ cannot subscribe to the presence state of a PBX telephone.

Also, SIP-aware PBXs exist that allow analog and digital PBX telephone sets to interface with both SIP and conventional PSTN networks. With such PBXs, analog and digital telephone sets can make and receive calls to and from SIP networks; unfortunately, SIP-aware PBXs do not currently provide presence capabilities. For example, a SIP UAC cannot subscribe to the presence state of a digital phone attached to the SIP-aware PBX.

Accordingly, there is a need for a presence aware Private Branch Exchange (PBX) and presence aware PBX system that has the capabilities of presence subscription, notification and management.

### SUMMARY OF THE INVENTION

The present invention provides for a presence aware Private Branch Exchange (PBX) and presence aware PBX system that has the capabilities of presence subscription, notification and management. The presence aware PBX and presence aware PBX system couple a conventional telephone set with a user agent client (UAC) and/or telephone. The presence capabilities can be achieved either through suitable modification of the PBX itself, in which case the modified PBX is referred to as a presence aware PBX, or through suitable coupling of the PBX to external system components which may include a subscription server or notification server, in which case the system is referred to as a presence aware PBX system, wherein the PBX is either a conventional PBX or a presence aware PBX.

In this context, subscribe or subscription refers to the process by which a first UAC user requests permission to monitor a second UAC or telephone user's presence state and the second UAC or telephone user grants permission for the first UAC user to monitor its presence state; notify or notification refers to the process by which a first UAC or telephone user sends its own presence state to another UAC user by using, for example, a Session Description Protocol (SDP) body which contains the specific definition of presence states within an XML document; and management refers to the process of how a first UAC or telephone changes its own presence state (manually by a user or automatically with the system) and where the first UAC displays the presence state of another UAC or telephone.

According to one embodiment of the invention, a non-symmetric presence aware PBX is coupled to an existing telephone set by a private network and a UAC by an IP network. The presence aware PBX and telephone set may be co-located and/or located a distance apart and/or coupled together by a wired or wireless link.

According to another embodiment, the invention is directed to a non-symmetric presence aware PBX system that includes a notification server that distributes a notification to a UAC.

According to another embodiment, the invention is directed to a non-symmetric presence aware PBX system that includes a subscription server that processes subscription requests. In such case, when the subscription server receives a subscription request, it will contact a user via a telephone to see if it is okay to grant the subscription. The subscription server preferably accepts a blanket request to grant all future re-subscriptions from the particular UAC and/or allows the user to cancel any subscription. In the latter case, the user may dial a number to interact with the subscription server using interactive voice response (IVR) means and/or the like, in order to cancel subscriptions to one or more prior subscribing UACs.

According to another embodiment, the invention is directed to a symmetric presence aware PBX system that includes a desktop comprised of a PBX telephone and associated UAC, wherein when the presence state changes on the telephone, the telephone signals a PBX of such change, the PBX notifies the associated UAC using an IP signaling means, such as, for example, CTI and/or the like, and the associated UAC subsequently notifies one or more remotely subscribed UACs of such change. In this embodiment, the associated UAC retains all of its existing symmetric capabilities relating to presence subscription, notification and management but is now further enhanced since the PBX telephone usage is now automatically conveyed to subscribers.

### BRIEF DESCRIPTION OF THE DRAWINGS

These and other features, aspects and advantages of the present invention will be more fully understood when considered with respect to the following detailed description, appended claims, and accompanying drawings where:

FIG. 1 is a system block diagram of an overall presence aware system, according to an exemplary embodiment of the invention;

FIG. 2 is a system functional block diagram that shows a non-symmetric presence aware PBX that allows a UAC to request and be granted a subscription to a telephone, and for the presence aware PBX to send notifications when the telephone changes its presence state, according to one embodiment of the invention;

FIG. 3 is a system functional block diagram that shows a non-symmetric presence aware PBX that allows a UAC to request and be denied a subscription to a telephone, according to one embodiment of the invention;

FIG. 4 is a functional block diagram of a non-symmetric presence aware PBX system that allows a telephone to notify a subscribed UAC of a presence change using a PBX and a notification server, according to one embodiment of the invention;

FIG. 5 is a functional block diagram of a non-symmetric presence aware PBX system that allows a UAC to request a subscription and re-subscription using a subscription server on behalf of a PBX, according to one embodiment of the invention; and

FIG. 6 is a functional block diagram of a symmetric presence aware PBX system where the UAC and telephone set are co-located, and wherein the UAC subscribes and grants subscriptions to a remote UAC, sends and receives notifications to and from a remote UAC, allows the user to manually manage his own presence state, displays the presence state of other UACs/users, and interworks with the PBX to automatically send notifications of the telephone presence state to one or more subscribed UACs, according to one embodiment of the invention.

### DETAILED DESCRIPTION OF THE SPECIFIC EMBODIMENTS

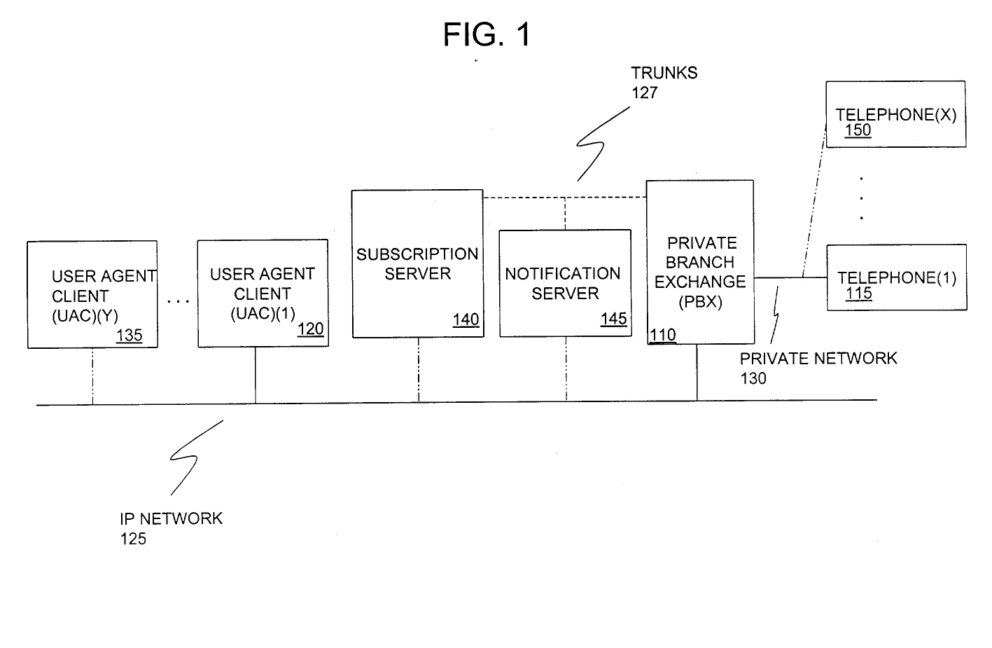

FIG. 1 is a system block diagram of an overall presence aware system, according to an exemplary embodiment of the invention. Telephones (1-X) 115-150 may be PBX legacy telephones using vendor-specific private digital and/or analog protocol. In this and other embodiments described herein, the description will be made primarily with reference to telephone (1) 115, with the understanding that the description applies equally as well to the other ones of the telephones (1-X) 115-150. In this and other embodiments described herein, the description will be made primarily with reference to UAC (1) 120, with the understanding that the description applies equally as well to the other ones of the UAC (1-Y) 120-135. The UACs (1-Y) 120-135 may be SIP-enabled personal computers, switches, routers, input/output cables, displays and/or the like for receiving and/or transmitting IP voice and/or data for allowing media communications. Telephones (1-X) 115-150 and UAC (1-Y) 120-135 in the exemplary embodiment reside in separate areas, coupled to each other over IP network 125 and private network 130; however, in another embodiment a telephone and a UAC may be co-located on a single desktop. PBX 110 is preferably a presence aware private switched PBX telephone system that is coupled to a public switching telephone network (PSTN). The presence capabilities can be achieved either through suitable modification of the PBX itself, in which case the modified PBX is referred to as a presence aware PBX, or through suitable coupling of the PBX to external system components which may include a subscription server or notification server, in which case the system is referred to as a presence aware PBX system, wherein the PBX is either a conventional PBX or a presence aware PBX. Private network 130 and devices connected to it, such as, for example, PBX telephones (1-X) 115-150, may adhere to vendor specific private digital and/or analog protocols, IP network 125 and devices connected to it, such as, for example, UAC (1-Y) 120-135, subscription server 140, and notification sever 145, may adhere to IP protocols, and trunk 127 and devices connected to it, such as, for example, notification server 145 and subscription server 140, may adhere to telephony trunk protocols. Communication between telephones (1-X) 115-150 and presence aware PBX 110, may use, but are not limited to, private digital signaling and voice (PDSV) to exchange signaling, voice and dual tone multi-frequency (DTMF) digits. Communication between presence aware PBX 110 and IP network 125 and between IP network 125 and other devices connected to it, such as, for example, notification server 145, subscription server 140, UAC (1-Y) 120-135, may use, but are not limited to, SIP, real time transport protocol (RTP) for media exchange computer supported telephony application (CSTA), computer telephone integration (CTI) and/or the like. Communication between presence aware PBX 110, notification server 145 and subscription server 140 over trunk 127, may use, but are not limited to, telephony trunk signaling and voice to exchange signaling, voice and DTMF digits.

The system includes UAC (1) 120 initiating a subscription request to telephone (1) 115 over IP network 125, such as, for example, a wide area network and/or the like, translating through PBX 110, which is presence aware here, over private network 130, such as, for example, a local area network and/or the like, to telephone (1) 115. The system may also include a user of telephone (1) 115 granting the subscription request back over private network 130, translating through presence aware PBX 110, over IP network 125 to UAC (1) 120. The system also may include the user of telephone (1) 115 initiating a change of presence, wherein UAC (1) 120, which is subscribed to telephone (1) 115, is notified of the presence change over private network 130, translating through presence aware PBX 110 and over IP network 125.

Alternatively, the system may include the user of telephone (1) 115 rejecting the subscription request back over private network 130, translating through presence aware PBX 110, over IP network 125 to UAC (1) 120. Lastly, the system may include the user of telephone (1) 115 initiating a change of presence, wherein UAC (1) 120, which is not subscribed to telephone (1) 115, is not notified of the presence change.

The presence aware PBX 110 is programmed with software that enables it to translate, generate and route presence signals. Presence aware PBX 110 may route calls between telephones (1-X) 115-150 and telephones (1-X) 115-150 and, where PBX 110 is SIP enabled, translates and routes calls between telephones (1-X) 115-150 and UACs (1-Y) 120-135.

Conventional PBX software determines if telephone (1-X) 115-150 is off- or on-hook and the software uses this information, for example, to source or stop sourcing dial tone. A modification to this conventional software may be made that enables transmission of the telephone (1-X) 115-150 off-hook or on-hook information to a notification server 145. If conventional computer supported telephony application (CSTA) or computer telephone integration (CTI) software is already resident within presence aware PBX 110, this software may be modified to suitably translate, generate and route the telephone (1-X) 115-150 off- or on-hook information to notification server 145 via IP signaling which may consist of SIP notifications. Alternatively, the notification server 145 may directly receive the telephone (1-X) 115-150 off- or on-hook information via CTI or CSTA so that it performs the subsequent translation, generation and routing of presence signals to notify subscribers.

The notification server 145 may also include interactive voice response (IVR) software that allows determination of other forms of notification in addition to off-hook and on-hook. For example, the IVR software could allow for the user to push DTMF key1 to indicate do-not-disturb, push DTMF key2 to indicate out-of-the-office, push DTMF key3 to indicate out-to-lunch, and the like on telephone (1) 115. The notification server 145 software may then transmit presence information to subscribed UAC (1-Y) 120-135.

Consequently, the system may use notification server 145 within the presence aware PBX system to handle notifications rather than the PBX 110. In such case, when the presence state changes for telephone (1-X) 115-150, PBX 110 will only have to forward one or more first notifications to notification server 145 and notification server 145 will translate the one or more first notifications, and generate and route one or more second notifications to one or more subscribed UACs (1-Y) 120-135 over IP network 125.

The conventional PBX software may also be enhanced in additional ways to translate, generate and route presence information so that the notification server is not required. In this case, the presence aware PBX would directly send on-hook or off-hook information to subscribers. Also if a presence aware PBX 110 already has voicemail or interactive voice response (IVR) software installed which allows, for example, pushing DTMF key1 to hear voicemail, pushing DTMF key2 to record voicemail, pushing DTMF key3 to delete voicemail, and/or the like on telephone (1) 115, the conventional software may be enhanced to allow for pushing DTMF key4 to indicate do-not-disturb, pushing DTMF key5 to indicate out-of-the-office, pushing DTMF key6 to indicate out-to-lunch, and/or the like on telephone (1) 115. The enhanced software may then transmit presence information elsewhere—either directly to subscribed UAC (1-Y) 120-135 or indirectly to the subscribed UAC (1-Y) 120-135 over notification server 145 and IP network 125 via IP signaling.

Therefore, if notification server 145 is provided, UAC (1-Y) 120-135 may determine the presence state of telephone (1-X) 115-150 even if the presence aware PBX 110 does not have the capability of exchanging SIP signaling since existing computer telephone integration (CTI) can communicate the telephone (1-X) 115-150 state to the notification server 145 which thereby issues appropriate notifications. Alternatively, notification server 145 may work in conjunction with presence aware PBX 110 IVR or voicemail system so that when the user of telephone (1-X) 115-150 dials the IVR or voicemail and interacts with it to designate the user's presence state, the notification server 145 subsequently informs subscribers of the user's presence change.

In a configuration with one or more UACs (1-Y) 120-135, the system may also use a subscription server 140 to handle subscriptions and re-subscriptions on behalf of PBX 110. When one or more UACs (1-Y) 120-135 want to subscribe to telephone (1) 115, subscription server 140 will receive one or more first subscription requests and will translate the one or more first subscription requests, and generate and route one or more second subscription requests over trunk 127, through PBX 110 and over private network 130 to telephone (1) 115. For example, upon the reception of one or more subscription requests from UAC (1-Y) 120-135, subscription server 140 may issue a message in the form of a voice call to the PBX telephone set querying the telephone set user for accepting/rejecting this subscription. Additionally, subscription server 140 may log initial subscription grants and automatically grant later re-subscriptions so that when a UAC (1-Y) 120-135 renews its subscription, subscription server 140 will handle the authorization rather than PBX 110 to telephone (1-X) 115-150.

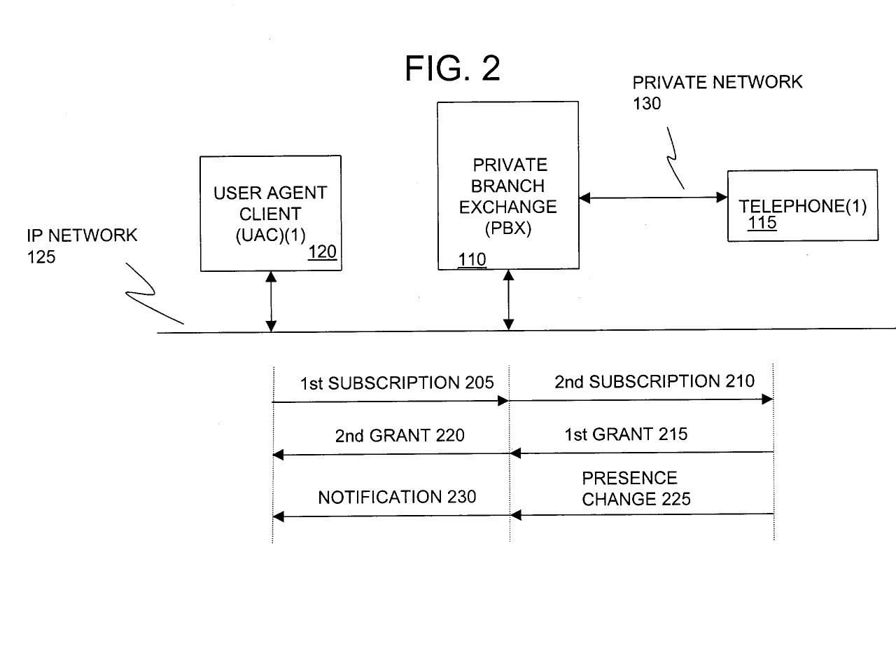

Following from FIG. 1, FIG. 2 is a system functional block diagram that shows a non-symmetric presence aware PBX that allows a UAC to request and be granted a subscription to a telephone, and for the presence aware PBX to send notifications when the telephone changes its presence state, according to one embodiment of the invention. In step 205 of the illustrated embodiment, presence aware PBX 110 receives a first subscription request from UAC (1) 120 over IP network 125, requesting permission to receive presence notification from telephone (1) 115. In step 210, presence aware PBX 110 translates the first subscription request, for example, a SIP subscribe, and generates a second subscription request, for example, a voice call, which is routed to telephone (1) 115 over private network 130. Presence aware PBX 110 then waits for a reply. The second subscription request, for example, rings telephone (1) 115 and verbally informs a user that UAC (1) 120 wishes to subscribe to his presence. In this case, in step 215, the user of telephone (1) 115 accepts the second subscription request and sends a first grant to presence aware PBX 110 over private network 130. The user of telephone (1) 115 may accept and generate the first grant in response to the second subscription request of step 210 through the use of dual tone multi-frequency (DTMF) dialing. In other embodiments, the user may also accept and generate the first grant in response to the second subscription request of step 210 through the use of preprogrammed soft-keys (for particular presence states) and/or speech recognition and/or the like. Thereafter, in step 220, presence aware PBX 110 translates the first grant, generates a second grant, such as, for example, a SIP OK, in response to the second subscription request, and then routes the second grant to UAC (1) 120.

If the user of telephone (1) 115 dials a particular extension to connect to an interactive voice response (IVR) and/or voice extensible markup language (VXML) server with which it interacts using DTMF (push number “1” to indicate “unavailable”, number “2” to indicate “out of the office”, and/or use the alphanumeric keypad to type the presence state and/or the like) and/or speech recognition/confirmation (say number “1” to indicate “unavailable”, number “2” to indicate “out of the office”, “yes or no” to confirm, cancel or reselect a selection and/or the like) his presence state changes. Consequently, in step 225, a presence change will be sent to presence aware PBX 110 for translation, generation and routing and, in step 230, a notification of such presence state change, for example, in the form of a SIP notify containing an SDP message body with XML fragment, will be sent to UAC (1) 120. If UAC (1) 120 periodically renews its subscription to telephone (1) 115 and the user of telephone (1) 115 has accepted an initial (second) request for subscription from UAC (1) 120, no later action need be taken at telephone (1) 115 since presence aware PBX 110 automatically translates, generates and routes subsequent grants.

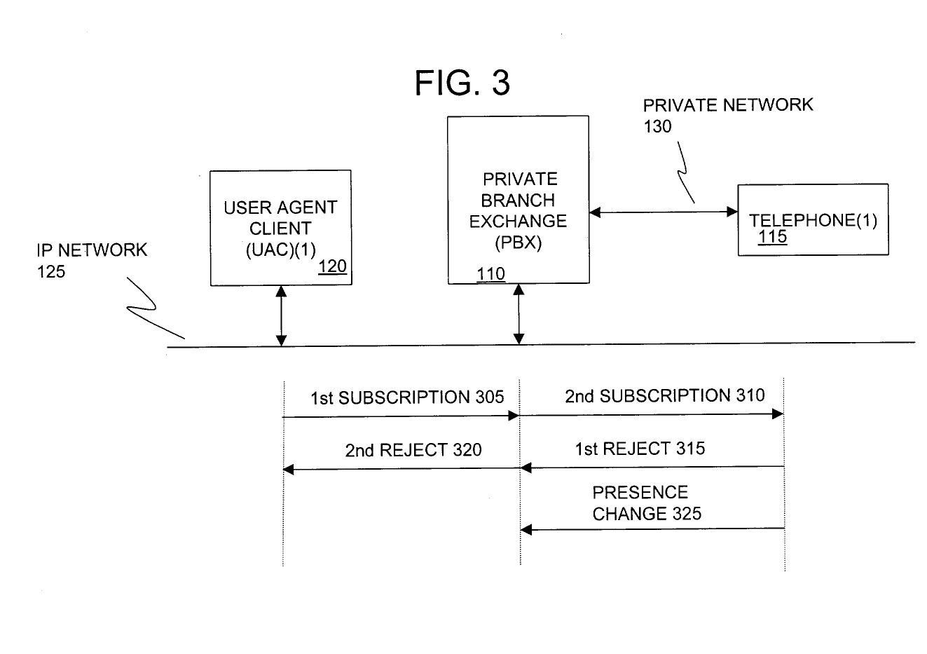

Following from the previous figures, FIG. 3 is a system functional block diagram that shows a non-symmetric presence aware PBX that allows a UAC to request and be denied a subscription to a telephone, according to one embodiment of the invention. In step 305 of the illustrated embodiment, presence aware PBX 110 receives a first subscription request from UAC (1) 120 over IP network 125, requesting permission to receive presence notification from telephone (1) 115. In step 310, presence aware PBX 110 translates the first subscription request for example, a SIP subscribe, and generates a second subscription request, for example, a voice call, which is routed to telephone (1) 115 over private network 130. Presence aware PBX 110 then waits for a reply. The second subscription request rings telephone (1) 115 and verbally informs a user that UAC (1) 120 wishes to subscribe to his presence. In this case, in step 315, the user of telephone (1) 115 denies the second subscription request and sends a first reject to presence aware PBX 110 over private network 130. The user of telephone (1) 115 denies and generates the first reject in response to the second subscription request of step 310 through the use of dual tone multi-frequency (DTMF) dialing. In other embodiments, the user may deny and generate the first reject in response to the second subscription request of step 310 through the use of preprogrammed soft-keys (for particular presence states) and/or speech recognition and/or the like. Thereafter, in step 320, presence aware PBX 110 translates the first reject, generates a second reject, such as, for example, a SIP message indicating rejected, in response to the second subscription request, and then routes the second reject to UAC (1) 120.

If the user of telephone (1) 115 dials a particular extension to connect to an interactive voice response (IVR) and/or voice extensible markup language (VXML) server with which it interacts using DTMF (push number “1” to indicate “unavailable”, number “2” to indicate “out of the office”, and/or use the alphanumeric keypad to type the presence state and/or the like) and/or speech recognition/confirmation (say number “1” to indicate “unavailable”, number “2” to indicate “out of the office”, “yes or no” to confirm, cancel or reselect a selection and/or the like) his presence state changes. Consequently, in step 325, a presence change will be sent to presence aware PBX 110 for translation, generation and routing; however, a notification of such presence state change will not be sent to UAC (1) 120 since this particular subscriber has not been authorized to monitor presence.

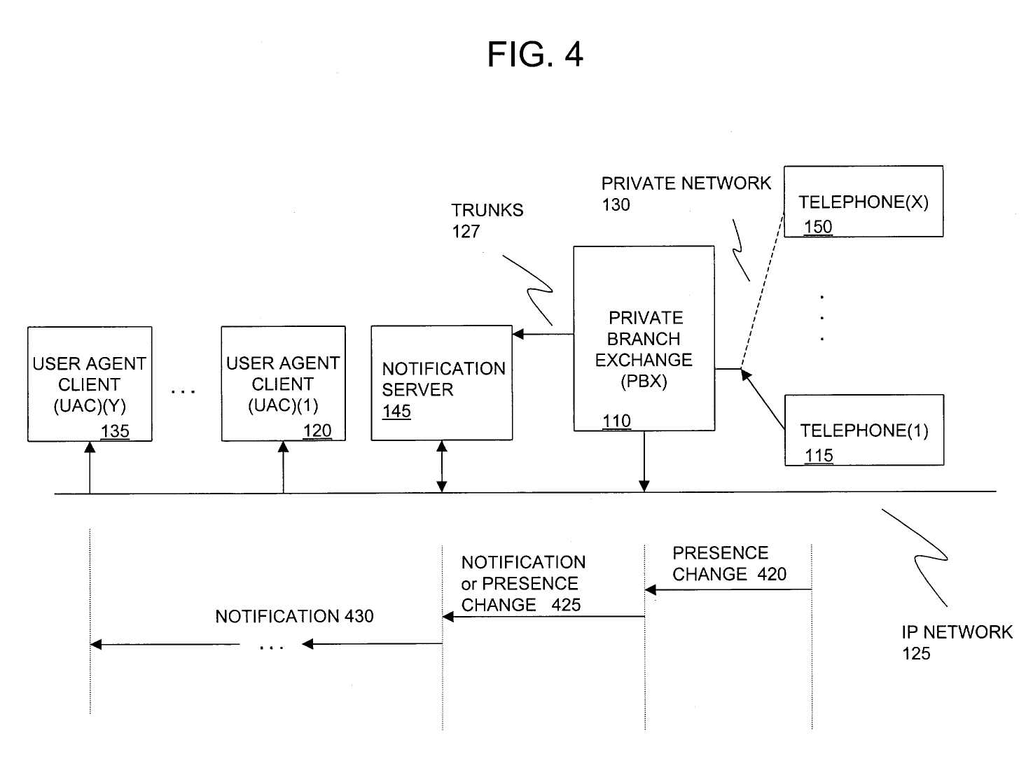

Following from the previous figures, FIG. 4 is a functional block diagram of a non-symmetric presence aware PBX system that allows a telephone to notify a subscribed UAC of a presence change using a PBX and a notification server, according to one embodiment of the invention. In step 420 of the illustrated embodiment, PBX 110 receives a presence change from telephone (1) 115 over private network 130 to indicate to its subscribed UAC (1-Y) 120-135 that its presence has changed. As a result, in step 425, PBX 110 either routes the presence change to notification server 145 so that notification server 145 can translate, generate and route a notification over IP network 125 to the subscribed UAC (1-Y) 120-135 in step 430, or translates, generates and routes a notification to notification server 145 and notification server 145 forwards the notification over IP network 125 to the subscribed UAC (1-Y) 120-135 in step 430. Additionally, telephone (1) 115 may specify its presence state to PBX 110, and PBX 110 may specify the presence state of telephone (1) 115 to notification server 145 via CTI so that subsequent notifications may be issued from notification server 145 to subscribed UAC (1-Y) 120-135, or, if the notification server 145 includes IVR, telephone (1) 115 can specify its presence state to the IVR so that subsequent notifications may be issued from notification server 145 to subscribed UAC (1-Y) 120-135. In this case, the notification server 145 may be a PC enabled with software, trunk interconnects and commercially available telephony boards.

As illustrated in FIG. 1, a modification to the conventional presence aware PBX 110 software may be made that enables transmission of the telephone (1) 115 presence information directly to notification server 145. If conventional computer supported telephony application (CSTA) or computer telephone integration (CTI) software is already resident within presence aware PBX 110, this software may be modified to suitably translate, generate and route the telephone (1) 115 presence information directly to notification server 145. Consequently, in step 420 of the illustrated embodiment, presence aware PBX 110 will receive a presence change from telephone (1) 115 over private network 130 to indicate to its subscribed UAC (1-Y) 120-135 that its presence has changed. As a result, in step 425, presence aware PBX 110 forwards the presence change of step 420 to notification server 145 so that notification server 145 can translate the presence change, and generate and route one or more second notifications to the subscribed UAC (1-Y) 120-135 over IP network 125 in step 430. Now, notification server 145 is performing the function that the presence aware PBX 110 may have performed by sending one or more of the second notifications to all the subscribed UAC (1-Y) 120-135 of telephone (1) 115.

Alternatively, the conventional PBX software may also be enhanced in additional ways to translate, generate and route presence information. For example, if presence aware PBX 110 already has voicemail or interactive voice response (IVR) software installed which allows, for example, pushing DTMF key1 to hear voicemail, pushing DTMF key2 to record voicemail, pushing DTMF key3 to delete voicemail, and/or the like, the conventional software may be enhanced to allow for pushing DTMF key4 to indicate do-not-disturb, pushing DTMF key5 to indicate out-of the-office, pushing DTMF key6 to indicate out-to-lunch, and/or the like. The enhanced PBX voicemail or IVR software may then transmit presence information elsewhere—either directly to subscribed UAC (1-Y) 120-135 or indirectly to the subscribed UAC (1-Y) 120-135 via notification server 145.

Therefore, if notification server 145 is provided, UAC (1-Y) 120-135 may determine the presence state of telephone (1-X) 115-150 even if the PBX 110 does not have the capability of exchanging SIP signaling since existing computer telephone integration (CTI) can communicate the telephone (1-X) 115-150 state to notification server 145 which thereby issues appropriate notifications. Alternatively, notification server 145 may work in conjunction with presence aware PBX 110 IVR or voicemail system so that when the user of telephone (1-X) 115-150 dials the IVR or voicemail and interacts with it to designate the user's presence state, the notification server 145 subsequently informs subscribers of the user's presence change.

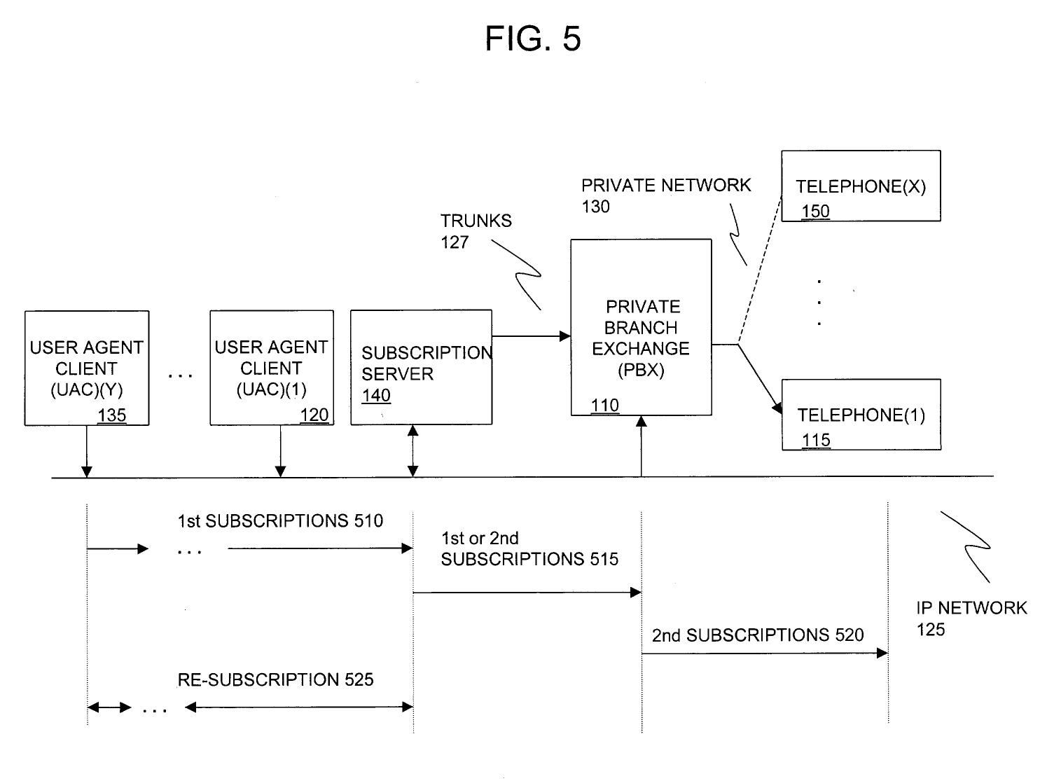

Following from the previous figures, FIG. 5 is a functional block diagram of a non-symmetric presence aware PBX system that allows a UAC to request a subscription and re-subscription using a subscription server on behalf of a PBX, according to one embodiment of the invention. When the one or more UACs (1-Y) 120-135 want to subscribe to telephone (1) 115, subscription server 140 will receive one or more first subscriptions from the one or more UACs (1-Y) 120-135 over IP network 125 in step 510, subscription server 140 will translate the one or more first subscriptions, and generate and route one or more second subscription requests over trunk 127 to PBX 110 in step 515 and PBX 110 will forward the one or more second subscription requests over private network 130 to telephone (1) 115 in step 520. In this case, the subscription server 140 may be a PC enabled with software, trunk interconnects and commercially available telephony boards. Therefore, upon the reception of one or more first subscription requests from UAC (1-Y) 120-135, subscription server 140 may issue a message in the form of a voice call directly to the telephone (1) 115 over trunk 127, through PBX 110 and over private network 130, querying the user of telephone (1) 115 to accept or reject the subscription. As a consequence, it is possible to offload some of the subscription tasks ordinarily performed by presence aware PBX 110 by using subscription server 140. Alternatively, subscription server 140 may receive one or more first subscriptions from the one or more UACs (1-Y) 120-135 in step 510, subscription server 140 may forward the one or more first subscription requests over IP network 125 to presence aware PBX 110 where presence aware PBX 110 translates the one or more first subscription requests, and generates and routes one or more second subscription requests over private network 130 to telephone (1) 115. In such case, PBX 110 may issue a message in the form of a voice call to the telephone (1) 115 querying the user to accept or reject the subscription. In either of the above cases, subscription server 140 may log initial subscription grants and automatically grant later re-subscriptions so that when a UAC (1-Y) 120-135 renews its subscription, subscription server 140 will handle the re-subscription 525 rather than PBX 110.

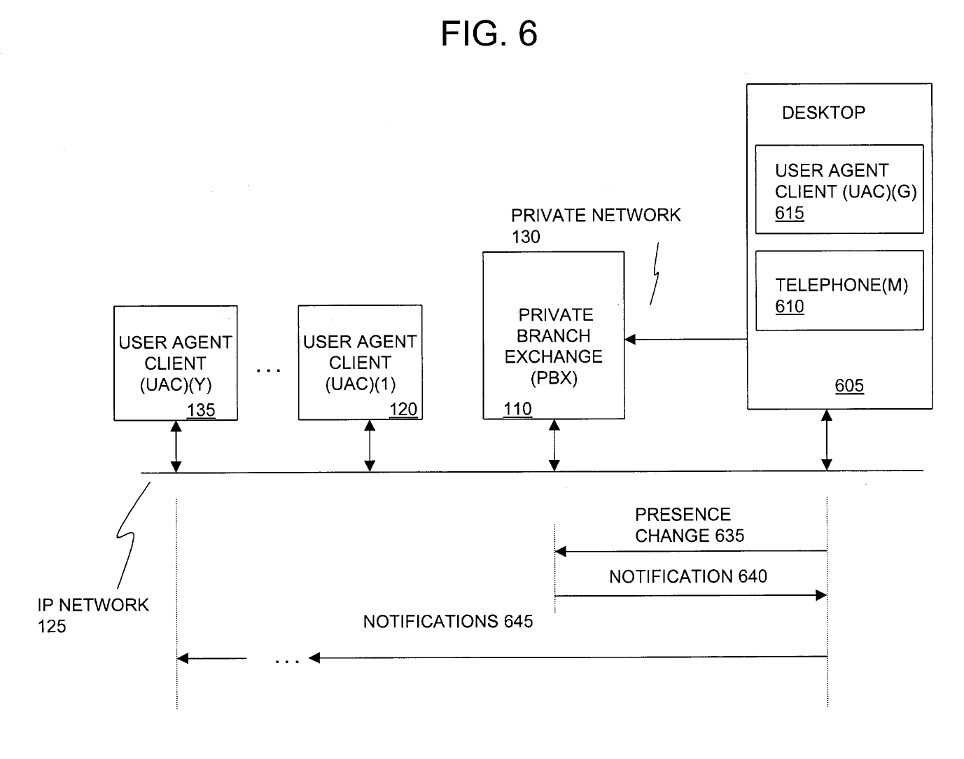

Following from the previous figures, FIG. 6 is a functional block diagram of a symmetric presence aware PBX system where the UAC and telephone set are co-located, and wherein the UAC subscribes and grants subscriptions to a remote UAC, sends and receives notifications to and from a remote UAC, allows the user to manually manage his own presence state, displays the presence state of other UACs/users, and interworks with the PBX to automatically send notifications of the telephone presence state to one or more subscribed UACs, according to one embodiment of the invention. UAC (G) 615 may be a software-modified version of a conventional UAC. The UAC (G) 615 software modification may include of adding the capability to receive CSTA and/or CTI and/or the like IP signaling information from PBX 110 over IP network 125 so that UAC (G) 615 can use this information to automatically adjust its presence state.

Although a conventional UAC typically requires a user to manually operate the graphical user interface (GUI) to designate the presence state, the UAC (G) 615 software modification within this embodiment, accomplished via algorithmic, table-lookup and/or other standard software means, also allows the presence state change to be made automatically, based upon receipt of information from PBX 110 via the IP signaling over IP network 125. Consequently, UAC (G) 615 has the additional functionality that enables its user to automatically adjust his presence state to on-the-phone or off-the-phone based upon the receipt of the IP signaling information from PBX 110 over IP network 125. In an exemplary embodiment, all other existing symmetric presence capabilities of UAC (G) 615 are retained. For example, UAC (G) 615 may retain all of its existing capabilities for displaying the presence state of other UACs, granting or denying subscriptions from other UACs and providing manual GUI-based control of its presence state and displaying the presence states of other UACs.

Consequently, in step 635, the presence change relating to off-hook or on-hook will be sent to PBX 110 and in step 640, a notification of such presence state change, which may be in the form of a CSTA or CTI message will be sent to UAC (G) 615 so that UAC (G) 615 can send one or more notifications to the subscribed UAC (1-Y) 120-135 in step 645.

Although this invention has been described in certain specific embodiments, those skilled in the art will have no difficulty devising variations which in no way depart from the scope and spirit of the present invention. It is therefore to be understood that this invention may be practiced otherwise than is specifically described. For example, although the above embodiments have been described with respect to the SIP protocol, a person skilled in the art should recognize that any other TCP/IP application layer (Layer 4) control protocol known in the art may be used instead of SIP, such as, for example, H.323, MGCP, or the like. The described embodiments are therefore not limited to the use of SIP messages. Thus, the present embodiments of the invention should be considered in all respects as illustrative and not restrictive, the scope of the invention to be indicated by the appended claims and their equivalents rather than the foregoing description.

What is claimed is:

1. A presence aware communications system comprising:
a first device;
a second device; and
a third device operative between the first device and the second device, wherein the first device transmits to the third device a first subscription request for establishing presence, the third device receiving the first subscription request and, in response, translating the first subscription request, and generating and routing a second subscription request to the second device based upon retrieved information in the first subscription request.

2. The system of claim 1, wherein the first device comprises a user agent client (UAC).

3. The system of claim 2, wherein the UAC comprises a session initiation protocol (SIP) enabled personal computer or a SIP enabled IP device.

4. The system of claim 1, wherein the second device comprises a private branch exchange (PBX) telephone.

5. The system of claim 1, wherein the third device comprises a presence aware private branch exchange (PBX).

6. The system of claim 1, wherein the retrieved information comprises information that identifies the second device.

7. The system of claim 1, wherein the first subscription request comprises an IP protocol subscription request or a session initiation protocol (SIP) subscription request.

8. The system of claim 1, wherein the translation is from IP to vendor specific private protocol.

9. The system of claim 1, wherein the second subscription request comprises a vendor specific private protocol subscription request, a private digital signaling and voice (PDSV) to exchange signaling protocol subscription request, an analog signal subscription request or a voice call.

10. The system of claim 1, wherein a user at the second device grants the second subscription request for presence.

11. The system of claim 10, wherein the second device transmits to the third device a first grant for establishing presence, the third device receiving the first grant and, in response, logging and translating the first grant, and generating and routing a second grant to the first device.

12. The system of claim 11, wherein the user grants the second subscription request through use of dual tone multi-frequency (DTMF) dialing, softkeys or speech recognition.

13. The system of claim 11, wherein the translation is from vendor specific private protocol to IP.

14. The system of claim 1, wherein a user at the second device rejects the second subscription request for presence.

15. The system of claim 14, wherein the second device transmits to the third device a first reject for establishing presence, the third device receiving the first reject and, in response, logging and translating the first reject, and generating and routing a second reject to the first device.

16. The system of claim 15, wherein the first reject comprises a vendor specific private protocol, a private digital signaling and voice (PDSV) to exchange signaling protocol, an analog signal reject or a voice call.

17. The system of claim 15, wherein the second reject comprises an IP protocol or a session initiation protocol (SIP) reject message.

18. The system of claim 16, wherein the user at the second device changes a presence state of the second device.

19. The system of claim 18, wherein the second device transmits to the third device a presence change, the third device receiving the presence change and, in response, translating the presence change, and generating and routing a notification to the first device.

20. The system of claim 19, wherein the notification comprises an IP protocol or a session initiation protocol (SIP) notify containing an session description protocol (SDP) message body with an extensible markup language (XML) fragment.

21. The system of claim 19, wherein the first device transmits to the third device a presence re-subscription request for confirming presence, the third device receiving the presence re-subscription request and, upon verifying the prior first grant in its log, re-transmitting the second grant to the first device to confirm presence.

22. The system of claim 1 further comprising a notification server coupled to the first device and third device, wherein when the second device transmits a presence change to the third device, the third device receives the presence change and, in response, translates the presence change, and generates and routes a notification to the notification server and the notification server routes the notification to the first device.

23. The system of claim 22, wherein the notification server comprises a PC enabled with software, trunk interconnects and commercially available telephony boards.

24. The system of claim 1 further comprising a notification server coupled to the first device and third device, wherein when the second device transmits a presence change to the third device, the third device receives the presence change and, in response, routes the presence change to the notification server and the notification server translates the presence change, and generates and routes a notification to the first device.

25. The system of claim 24, wherein the notification server comprises a PC enabled with software, trunk interconnects and commercially available telephony boards.

26. The system of claim 24, wherein the notification receives computer supported telephony application (CSTA) protocol or a computer telephone integration (CTI) protocol.

27. The system of claim 1 further comprising a subscription server coupled to the first device and third device, wherein when the first device transmits a first subscription to the subscription server, the subscription server receives the first subscription and, in response, translates the first subscription, and generates and routes a second subscription to the third device and the third device routes the second subscription to the second device.

28. The system of claim 27, wherein the subscription server comprises a PC enabled with software, trunk interconnects and commercially available telephony boards.

29. The system of claim 27, wherein the subscription server logs a first grant originating from the second device.

30. The system of claim 29, wherein the first device transmits to the subscription server a presence re-subscription request for confirming presence, the subscription server receiving the presence re-subscription request and, upon verifying the first grant in its log, re-transmitting a second grant to the first device to confirm presence.

31. The system of claim 1 further comprising a subscription server coupled to the first device and third device, wherein when the first device transmits a first subscription to the subscription server, the subscription server receives the first subscription and, in response, routes the first subscription to the third device and the third device translates the first subscription, and generates and routes a second subscription to the second device.

32. The system of claim 31, wherein the subscription server comprises a PC enabled with software, trunk interconnects and commercially available telephony boards.

33. The system of claim 31, wherein the subscription server logs a first grant originating from the second device.

34. The system of claim 33, wherein the first device transmits to the subscription server a presence re-subscription request for confirming presence, the subscription server receiving the presence re-subscription request and, upon verifying the first grant in its log, re-transmitting a second grant to the first device to confirm presence.

35. A presence aware private branch exchange (PBX) communications system comprising:
a first device;
a second device; and
a third device operative between the first device and the second device, wherein the second device transmits to the third device a presence change, the third device receiving the presence change and, in response, translating the presence change, and generating and routing a notification to the second device and the second device forwarding the notification to the first device.

36. The system of claim 35, wherein the first device comprises a user agent client (UAC).

37. The system of claim 36, wherein the UAC comprises a session initiation protocol (SIP) enabled personal computer or a SIP enabled IP device.

38. The system of claim 35, wherein the second device comprises a private branch exchange (PBX) telephone and software modified user agent client (UAC)

39. The system of claim 38, wherein the software modified UAC comprises a PC enabled with software.

40. The system of claim 35, wherein the third device comprises a private branch exchange (PBX).

41. A method for establishing a presence aware communications system between a first, second and third device, the method comprising:
receiving a first subscription request from the first device for establishing presence;
operating on the first subscription request to result in a second subscription request; and
transmitting the second subscription request to the second device based upon retrieved information in the first subscription request.

42. The method of claim 41, wherein operating on the first subscription request comprises translating the first subscription request, and generating and routing the second subscription request by the third device.

43. The method of claim 41, wherein the information comprises information gathered about a user of the second device.

44. The method of claim 41, further comprising transmitting a first grant by the second device for establishing presence, receiving the first grant by the third device, operating on the first grant by the third device to result in a second grant, and transmitting the second grant to the first device.

45. The method of claim 44, wherein operating on the first grant comprises logging the first grant in memory, translating the first grant, and generating and routing the second grant.

46. The method of claim 45, further comprising transmitting a presence re-subscription request by the first device for confirming presence, receiving the presence re-subscription request by the third device, verifying the prior first grant by the third device, and re-transmitting the second grant to the first device to confirm presence.

47. The method of claim 46, wherein verifying the first grant comprises searching for the first grant log in the memory in the third device.

48. The method of claim 41, further comprising transmitting a first reject by the second device for establishing presence, receiving the first reject by the third device, operating on the first reject by the third device to result in a second reject, and transmitting the second reject to the first device.

49. The method of claim 48, wherein operating on the first reject comprises logging the first reject in memory, translating the first reject, and generating and routing the second reject.

50. The method of claim 45, further comprising transmitting a presence change by the second device, receiving the presence change by the third device, operating on the presence change by the third device to result in a notification, and transmitting the notification to the first device.

51. The method of claim 45 further comprising transmitting a presence change by the second device, receiving the presence change by the third device, operating on the presence change by the third device to result in a notification, transmitting the notification by the third device, receiving the notification by a notification server, and transmitting the notification to the first device.

52. The method of claim 45 further comprising transmitting a presence change by the second device, receiving the presence change by the third device, transmitting the presence change by the third device, receiving the presence change by a notification server, operating on the presence change by the notification server to result in a notification, transmitting the notification by the notification server to the first device.

53. The method of claim 41, wherein receiving comprises receiving the first subscription request at a subscription server.

54. The method of claim 53, wherein operating comprises operating on the first subscription request by the subscription server.

55. The method of claim 54, further comprising transmitting a first grant by the second device for establishing presence, receiving the first grant by the third device, operating on the first grant by the third device to result in a second grant, and transmitting the second grant to the subscription server and the first device.

56. The method of claim 55, wherein the subscription server logs the second grant in memory.

57. The method of claim 56, further comprising receiving a presence re-subscription request for confirming presence by the subscription server, verifying the second grant by the subscription server in its memory, and re-transmitting the second grant to the first device to confirm presence.

58. The method of claim 53, wherein operating comprises operating on the first subscription request by the third device.

59. The method of claim 58, further comprising transmitting a first grant by the second device for establishing presence, receiving the first grant by the third device, operating on the first grant by the third device to result in a second grant, and transmitting the second grant to the subscription server and the first device.

60. The method of claim 59, wherein the subscription server logs the second grant in memory.

61. The method of claim 60, further comprising receiving a presence re-subscription request for confirming presence by the subscription server, verifying the second grant by the subscription server in its memory, and re-transmitting the second grant to the first device to confirm presence.

62. A method for establishing a presence aware private branch exchange (PBX) communications system between a first, second and third device, the method comprising:
receiving a presence change from the second device;
operating on the presence change to result in a notification;
receiving the notification from the third device; and
transmitting the notification to the first device.
